(19) United States
(12) Patent Application Publication
(10) Pub. No.: US 2019/0185681 A1
(43) Pub. Date: Jun. 20, 2019

(54) POLYMERIC FUNCTIONALIZED ROOFING PELLETS

(71) Applicant: Building Materals Investment Corporation, Dallas, TX (US)

(72) Inventors: Eric R. Anderson, Montclair, NJ (US); Sudhir Railkar, Wayne, NJ (US)

(21) Appl. No.: 15/845,918

(22) Filed: Dec. 18, 2017

(51) Int. Cl. C09D 5/14; C09D 123/12; C09D 123/06; C09D 7/61; A01N 59/20

(52) U.S. Cl. CPC C09D 5/14; C09D 123/12; C08K 2003/085; C09D 7/61; A01N 59/20; C09D 123/06

(57) ABSTRACT

The present disclosure relates, according to some embodiments, to a method of slowing the growth of at least one microorganism on a surface, the method may comprise: applying a plurality of pellets to the surface, wherein each pellet of the plurality of pellets may comprise a polymer matrix and an antimicrobial agent, wherein the antimicrobial agent is dispersed throughout the volume of the polymer matrix, wherein natural weathering of the plurality of pellets releases the antimicrobial agent at a substantially uniform rate over a period of about or more than 20 years, and wherein the release of the antimicrobial agent slows the growth of microorganisms on a surface.

### FIELD OF THE DISCLOSURE

The present disclosure relates, in some embodiments, to roofing products, such as roof coverings, that may comprise polymeric functionalized roofing pellets.

### BACKGROUND OF THE DISCLOSURE

Roofing granules are used in roofing products such as roll roofing and asphalt shingles. Roofing granules may be applied to or embedded in the asphalt coating on the surface of the asphalt-impregnated base material. The granules may form a coating that provides an adherent and protective exterior roofing surface. In some circumstances, roofing granules may be coated with an active ingredient and then coated with a ceramic layer to prevent immediate release of the active ingredient. However, such arrangement may result in decreased access to the active ingredient over time and decreased release of the active ingredient over time. Such arrangement may also prevent access to the active ingredient layer disposed on the granule surface contacting the asphalt coating of the roofing product. Such arrangement may also limit the type of active ingredient that can be incorporated into a roofing granule. These factors and others can contribute to incomplete release of an active (e.g., less than 30 wt. % of an antimicrobial released over a 20 year period). In addition, active ingredients may be released in a non-uniform manner (e.g., at a decaying rate over time).

### SUMMARY

Accordingly, a need has arisen for improved roofing products that may provide for controlled release of active ingredients, more efficient use of active ingredients incorporated, and/or allow for the incorporation of a greater variety of active ingredients. The present disclosure relates, according to some embodiments to a roofing product that may comprise a bituminous base and a plurality of roofing pellets adhered to the bituminous base. A plurality of pellets may comprise a polymer matrix mixed with an active ingredient. An active ingredient may be dispersed throughout the volume of a polymer matrix. An active ingredient may provide an additional functionality to the roofing product.

In some embodiments, a method of manufacturing a roofing product may comprise mixing a polymer matrix with an active ingredient that may form a plurality of pellets such that the active ingredient may be dispersed throughout the volume of the polymer matrix. An active ingredient may have antimicrobial activity, flame retardant activity, or both antimicrobial and flame retardant activity; and directly adhering the plurality of roofing granules to an exterior surface of a bituminous base.

A method of slowing the growth of at least one microorganism on a surface, the method may comprise applying a plurality of pellets to the surface. Each pellet of a plurality of pellets may comprise a polymer matrix and an antimicrobial agent. An antimicrobial agent may be dispersed throughout the volume of the polymer matrix. Natural weathering of a plurality of pellets may release a antimicrobial agent at a substantially uniform rate over a period of about or more than 20 years. A release of an antimicrobial agent may a growth of microorganisms on a surface.

According to some embodiments, a method of slowing a spread of a surface fire may comprise applying a plurality of pellets to a bituminous base. Each pellet of a plurality of pellets may comprise a polymer matrix and a fire suppressant. A fire suppressant may be dispersed throughout a volume of a polymer matrix. A polymer matrix may be configured to melt at a temperature of about 50° C. less than a combustion temperature of a bituminous base. A melting of a polymer matrix may release a fire suppressant at a substantially uniform rate. A release of a fire suppressant may slow a spread of a surface fire.

According to some embodiments, a method of releasing an active ingredient to a surface of a shingle at a substantially uniform rate over a period of years may comprise affixing the shingle to an exterior surface. A shingle may comprise a bituminous base and a plurality of roofing pellets adhered to the bituminous base. A plurality of pellets may comprise a polymer matrix mixed with an active ingredient. An active ingredient may be dispersed throughout a volume of a polymer matrix, contacting a shingle surface to an environmental stimulant. Contacting a shingle surface to an environmental stimulant may release an active ingredient from a plurality of pellets. An active ingredient may provide an additional functionality to the roofing product.

In some embodiments, an active ingredient may be an antimicrobial agent. An antimicrobial agent may be selected from the group consisting of metal oxides, metal borates, metal powders, powders of metal alloys, copper compounds, metal sulfides, metal salts, organo-metallic compounds, and combinations thereof. An active ingredient may be released through natural weathering of the plurality of roofing granules. An active ingredient may be a flame suppressant. A flame suppressant may be selected from the group consisting of aromatic polyamides, polypropylenes, polyesters, polyimides, copolymers thereof, polybrominated dibenzodioxins, polybrominated dibenzofurans, brominated diphenyl ethers, phosphorous tribromide, phosphorous trichloride, aluminum hydroxide, magnesium hydroxide, and combinations thereof. Release of the active ingredient may be heat activated.

Release of the active ingredient may occur at about a temperature from about 200° F. to about 600° F. A distribution of an active ingredient throughout the polymer matrix may provide for substantially uniform release of the active ingredient over a period of time of about 30 years. A ratio of an active ingredient to the polymer matrix may be from about 90:10 to about 1:99. A plurality of pellets may each have a diameter from about 0.25 mm to about 5.0 mm. A polymer matrix may comprise at least one of a stabilizing agent, de-stabilizing agent, and pigment. An active ingredient may be non-water soluble. An active ingredient may be a liquid. An active ingredient may be active by natural degradation of the polymer matrix. An active ingredient may be an antimicrobial agent. A polymer may be selected from the group consisting of high density polyethylene, low density polyethylene, linear low density polyethylene; polypropylene; low and high impact polystyrene, polyvinyl chloride, acrylonitrile butadiene styrene, polyamide, polyester, polycarbonate, polyester, polyurethane, styrene butadiene styrene, styrene-butadiene rubber, styrene ethylene butylene styrene rubber, and acrylic.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

Some embodiments of the disclosure may be understood by referring, in part, to the present disclosure and the accompanying drawings, wherein:

FIG. 1A illustrates a scanning electron micrograph of a polyethylene roofing pellet according to a specific example embodiment of the disclosure;

FIG. 1B illustrates a scanning electron micrograph of a polyethylene roofing pellet according to a specific example embodiments of the disclosure;

FIG. 2A is a photograph of an unaged polypropylene roofing pellet according to a specific example embodiment of the disclosure;

FIG. 2B is a photograph of an artificially aged polypropylene roofing pellet according to a specific example embodiment of the disclosure; and

FIG. 3 is a bar chart of data for leaching an active ingredient from pellet samples according to a specific example embodiment of the disclosure.

### DETAILED DESCRIPTION

The present disclosure relates, in some embodiments, to roofing products, such as roof coverings or roofing shingles. Roofing products may comprise polymeric functionalized roofing pellets. Various active ingredients may be incorporated into roofing pellets to provide for various functions. For example, in some embodiments, antimicrobial agents may be mixed with a polymer matrix to provide for an antimicrobial effect. An antimicrobial agent may desirably slow and/or prevent naturally occurring growth of algae and/or other microorganisms on a roofing structure. In some embodiments, a flame suppressant may be mixed with a polymer matric to provide for a flame resistant effect. A flame suppressant may desirably slow and/or prevent a spread of a fire on a roofing structure. Active ingredients may be dispersed and/or distributed throughout a polymer matrix such that a roofing product desirably provides for uniform and/or controlled release of active ingredients over a period of time.

A roofing product according to some embodiments of the present disclosure may comprise a bituminous base. In some embodiments, a bituminous base is a bituminous material derived from a petroleum processing by-product such as pitch, “straight-run” bitumen, or “blown” bitumen. A bituminous material can be modified with extender materials such as oils, petroleum extracts, and/or petroleum residues. A bituminous material can include various modifying ingredients such as polymeric materials, such as SBS (styrene-butadiene-styrene), block copolymers, resins, oils, flame-retardant materials, oils, stabilizing materials, anti-static compounds, and the like. A bituminous material may also include a suitable filler, such as calcium carbonate, talc, carbon black, stone dust, or fly ash.

According to some embodiments, a roofing product may comprise a plurality of roofing pellets. A plurality of roofing pellets may be adhered to a bituminous base. Roofing pellets may be distributed over selected portions of a top of a roofing sheet, and a bituminous material may serve as an adhesive to bind a plurality of roofing pellets to a sheet when a bituminous material has cooled.

Roofing pellets of the present disclosure may desirably provide for various other functionality through an incorporation of active ingredients. In some embodiments, a roofing product may comprise a plurality of roofing pellets. Pellets may comprise suitable polymeric materials. Functionalized pellets may have various sizes and particle size distributions, shapes, and/or distribution throughout a roofing product. For example, with respect to size, pellets may have a diameter of between about 0.25 mm to about 5.0 mm. For example, pellets may have a diameter of between about 0.25 mm to about 1.0 mm, or of between about 1.0 mm to about 3.0 mm, or of between about 3.0 mm to about 5.0 mm Pellets may have a diameter of between about 0.75 mm and about 1.5 mm Pellet diameter may be substantially uniform or may substantially vary. With respect to shapes, pellets may be shaped as a sphere, spheroid, cuboid, pyramid, polyhedron, ovoid, cylinder, elliptical cylinder, triangular prism, tetrahedron, cone, or other suitable geometry. In some embodiments, a shape of a pellet may desirably provide for physical or chemical property adjustments. For example, a roofing product may comprise a plurality of elliptical cylinder shaped pellets that may permit desirable or uniform pellet dispersion throughout a bituminous base in comparison to a corresponding roofing product may comprise pellets of a different shape. A uniform pellet dispersion may be a result of a homogenous mixing ability and/or a resistance to segregation from other particles on a roofing product. For example, pellet or pellet particles with less spherical shapes (e.g., elliptical cylinder) may be less likely to segregate from standard granules. Additionally, elliptical cylinder pellets may be less likely to roll on their side and flat faces and/or edges may be more likely to catch in interstitial areas of granules both in a pile and on a shingle. A uniform pellet dispersion may desirably provide for a substantially uniform active ingredient activity from pellets. For example, a roofing product having a plurality of elliptical cylinder shaped pellets that may comprise an antimicrobial agent that may desirably provide for a substantially uniform antimicrobial activity for the roofing product, thereby substantially preventing microbial growth on a surface of the roofing product. Additionally, some pellet shapes may promote or suppress release of an active ingredient.

A roofing pellet may comprise one or more polymeric materials, the nature, ratio, and/or concentrations of which may be selected to give a finished pellet a desirable decomposition rate when exposed to one or more environmental stimuli (e.g., heat or natural weathering). In some embodiments, roofing pellets may comprise a polymer matrix. A polymer matrix may comprise various polymeric compounds. For example, a polymer matrix may comprise homopolymers or copolymers that are linear or branched. Copolymers may be random, alternating or block; and either class may have superstructure such as comb or dendritic characteristics. Examples of polymeric compounds may include acrylic copolymers, polyesters, polyamides, epoxies, nonacid-containing polyolefins, polyolefin alloys, polypropylene, acid-containing polyolefins, polyvinyl chloride, polyester block amide, ethylene-chlorotrifluorethylene, nylons, and polyvinylidene fluoride. A specific polymer material may be selected by properties of outdoor durability by weathering or biodegradability, compatibility with an active agent, physical and process properties. In some embodiments, the carrier could also be thermoplastic or thermoset. Preferably, polymeric compounds may be selected from high density polyethylene, low density polyethylene, linear low density polyethylene; polypropylene; low and high impact polystyrene, polyvinyl chloride (PVC), acrylonitrile butadiene styrene (ABS), polyamide, polyester, polycarbonate, polyester, polyurethane, styrene butadiene styrene (SBS), styrene-butadiene rubber (SBR), styrene ethylene butylene styrene rubber (SEBS), and acrylic.

Pellets for a roofing product may also comprise an active ingredient. Active ingredients may be mixed with, dispersed throughout, or otherwise incorporated into a polymer matrix. Active ingredients may be distributed such that the active ingredients are disposed throughout the volume of a polymer matrix of a pellet. Distribution of active ingredients throughout a polymer matrix or throughout a pellet may be homogeneous or heterogeneous. In some embodiments, a distribution of each active ingredient throughout a polymer matrix or throughout a pellet may be substantially uniform or uniform.

Active ingredients may be chosen based on functionality conferred, compatibility with a polymer matrix, activation condition, and other properties. For example, an active ingredient may be an antimicrobial agent, which may provide increased algae resistance and prevent a growth of microorganisms. As another example, an active ingredient may be a flame suppressant, which may help prevent a spread of a fire on a roofing product. As still another example, an active ingredient may be a color pigmentation, which may help maintain the coloration and aesthetics of a roofing product throughout use and weathering. Active ingredients may be provided by way of example only, and other active ingredients may be used in present embodiments without departing from the instant disclosure. The presently described pellets may comprise active ingredients that may be considered functionalized pellets. When a roofing product including the functionalized pellets is installed for use, active ingredients may become available over time, for example, through natural weather-induced degradation or other environmental stimuli.

### Controlled Delivery

A roofing product may comprise pellets, according to some embodiments, may provide performance enhancements and additional functionalities. A roofing product may comprise pellets having a single formulation or may comprise a variety of pellets, each having different properties. For example, a roofing product may comprise two or more types of pellet with distinguishing features selected from, for example, polymer composition (nature, ratio, concentration), active ingredient (e.g., number, function, concentration) and other ingredients (if present, nature, concentration, function). It may be desirable, for example, to achieve a selected lifespan of a product to use two or more polymeric matrices, one or more configured to release its active ingredient(s) earlier in a lifespan and one or more configured to release its active ingredient(s) later in the lifespan.

Pellet formulations may vary based on desired effects, duration of performance, and material compatibilities. For example, in some embodiments, active ingredients may be distributed so as to promote controlled and/or uniform delivery of active ingredients over time. Roofing pellets of the present disclosure may have active ingredients that are not localized but are distributed evenly or substantially evenly throughout a roofing pellet. An even distribution may desirably allow for more uniform distribution over time and/or may reduce or prevent decay in the availability of active ingredients over time.

In some embodiments of the present disclosure, water can leach active ingredients from an exterior surface of a roofing pellet. Active ingredients disposed on an exterior surface of a roofing pellet may be available to be leached immediately. In some embodiments, as a roofing pellet is degraded by natural weathering or other environmental stimuli, an exterior surface may be eroded. As a roofing pellet degrades, additional surface area may be created and additional pathways to active ingredients may be created or become accessible. As a roofing pellet degrades, more active ingredients within a roofing pellet may become exposed and/or easily accessible to be leached by water. An amount of active ingredients accessible to be leached by water may not decreased over a period of time. Water may not have to travel a significantly greater distance to access active ingredients over a period of time.

In some embodiments of the present disclosure, roofing products may comprise pellets and may be installed for standard use may release substantially all (e.g., all) of an active ingredient contained in the pellets over a desired period of time, which may be exigent in the case of flame retardant actives (e.g., about 1 second to about 5 minutes of attaining a threshold temperature, local atmospheric air or oxygen concentration, or other metric of fire or fire risk factors), or extended in a case of an antimicrobial actives (e.g., about or more than 1 year, about or more than 5 years, about or more than 10 years, about or more than 15 years, about or more than 20 years, about or more than 25 years, or about or more than 30 years). Polymer selection, other components in a roofing product and/or knowledge of the environmental stimuli (e.g., combustion temperatures of materials in close proximity, annual weather patterns) may allow the rate of release of an active ingredient contained in polymeric pellets to be predicted and/or configured as desired. In some embodiments, a roofing product may comprise pellets that may have less than about 70 wt. % of an active ingredient remaining after such defined period. For example, a roofing product having pellets with antimicrobial agent therein may, after being exposed to natural weathering and degradation for 20 years, have less than about 70% of the original antimicrobial agent remaining. In some embodiments, an amount of active ingredients remaining after 20 years may be less than about 60%, less than about 50%, less than about 40%, less than about 30%, or less than about 20%, or less than about 10%, or less than about 5%.

According to some embodiments, a roofing product may comprise pellets and may release an active ingredient upon exposure to heat or a flame source. For example, pellets may release a flame retardant, flame suppressant, or flame resistant material instantaneously (e.g., about 1 second to about 5 minutes) or steadily upon exposure to a threshold temperature and/or flame source. A pellet may comprise a flame or heat active component may release said flame or heat active component at various temperatures. For example, a pellet may release a flame active agent at a temperature from about 200° F. to about 600° F. A pellet may release a flame active agent at a temperature of below about 200° F., or below about 250° F., or below about 300° F., or below about 350° F., or below about 400° F., or below about 450° F., or below about 500° F., or below about 550° F., or below about 600° F. In some embodiments, a pellet may be configured to release a flame or temperature active component below a flash point of bitumen. For example, a pellet may be configured to release a flame or temperature active component about 300° F. below a flash point of a bitumen, or about 350° F. below a flash point of the bitumen, 200° F. below the flash point of the bitumen, or about 150° F. below the flash point of the bitumen, or about 100° F. below the flash point of the bitumen, or about 50° F. below the flash point of the bitumen, or about 25° F. below the flash point of the bitumen. A flash point of a bitumen, or bituminous base may be about 400° F.

In some embodiments, a roofing product and/or a roofing pellet may be configured to have a substantially uniform or uniform amount or concentration of available active ingredient at its surface over a desired period of time. Once released, an active ingredient may have a limited period during which it is active. For example, an active component may itself be degraded or removed by exposure to environmental stimuli. A rate at which these may occur may be taken into consideration with configuring a roofing pellet (e.g., selecting the nature and composition of polymer(s) to include in such pellet). For example, attention may be given to a concentration or quantity of active ingredient at a surface instead of or in addition to a release rate.

In some embodiments of the present disclosure, polymeric pellets may be desirably configured to have a more uniform rate (e.g., a uniform rate) of release of an active ingredient when compared to granules coated with the same active ingredient. Release rates from such granules may decay over time, decreasing significantly or exponentially as, for example, it becomes it becomes increasingly difficult for water (or other environmental stimuli) to access and release an active ingredient. Embodiments in which an active is uniformly or substantially uniformly distributed in a polymeric polymer with a constant or substantially constant rate of decomposition and/or a uniform or substantially uniform exposure to environmental stimuli may allow pellets to more uniformly release an active ingredient over a desired period of time, whether short, as may be desired for fire retardants, or extended as may be desired for antimicrobials.

Some embodiments of the present disclosure also provide for more efficient usage of active ingredients. Roofing granules applied to an asphalt sheet may lodge at some depth in the asphalt sheet. Water may be prevented from forming or entering pores on an embedded portion of a roofing granule to access active ingredients. Further, a base particle rock may also prevent access to active ingredient layer disposed primarily on an underside of a roofing granule (a surface contacting a asphalt), making that portion of active ingredients much more difficult or impossible for water to reach. Active ingredients disposed in or on an embedded granule are inefficiently and ineffectively positioned as they increase a overall cost of a roofing product without added benefit or added functionality.

In some embodiments, roofing pellets may comprise an active ingredient may be adhered to an asphalt sheet at or on its surface, for example, substantially without or without being embedded therein. Being positioned at or on a surface of an asphalt sheet may increase a relative surface area exposed to water (or other stimuli) compared to an embedded granule or pellet. In some embodiments, a roofing pellet may comprise a polymer with a substantially uniform or uniform rate of decomposition upon exposure to one or more stimuli (e.g., natural weathering, excessive heat). Uniform decomposition may reduce or prevent formation of channels or pores in a roofing pellet, but instead allow substantially uniform or uniform erosion across its exposed surface.

### Range and Concentration of Active Ingredients

Some embodiments of the present disclosure also may desirably provide for a use of a broad range of active ingredients. For example, an active ingredient may be a liquid. In some embodiments of the present disclosure, pellets may not have an inherent pore structure. Pathways to active ingredients may be formed through deterioration of or sloughing off of a polymer matrix material. Using liquid active ingredients may be suitable as a liquid active ingredient may be mixed with a polymer matrix and may not escape through a porous structure before it is leached or before it can impart its functionality. A liquid may comprise an oil or a low melting wax. A wax may, for example, melt below a temperature of a roof surface such as below about 180° F. An oil or wax with a melting temperature below a roof surface temperature may attract or repel insects. An active ingredient may comprise a dye, which may desirably permit leak tracing. For example, a dye or water soluble pigment that are UV activated may enable leak tracing. A liquid may comprise an agent that may attract or repel insects.

In some embodiments, a roofing product may comprise an insect attracting active ingredient. For example, a roofing product may comprise roofing pellets comprising an insect attracting agent. A roofing product comprising an insect attracting active ingredient may provide for an attraction of insects towards a roofing product. Attracting insects towards a roofing product may desirably attract insects away from an inhabited area, such as a deck or dwelling area. Attracting insects towards a roofing product may also desirably protect other building structures or other areas from insects. In some embodiments, an insect attracting active ingredient may also be used if the presence of an insect is desirable. For example, a roofing product used in a butterfly garden may comprise an insect attracting active ingredient for attracting butterflies. As another example, a roofing product may comprise an insect attracting active ingredient for attracting bees so as to promote pollination.

According to some embodiments, an active ingredient may include an anti-moss or anti-microbial agent that may repel or inhibit growth of an algae (e.g., Gloeocapsa Magma). An anti-moss or anti-microbial treatment may be used to wash or clean a roof. In some embodiments, an active ingredient may comprise a process oil or pigment, which may invigorate or change a color of a roofing product, a bituminous base, at least one roofing pellet, or a combination thereof. A pigment may be released upon aging, wreathing, or as a result of an impact above a certain force level. In some embodiments, a pigment could be released from a pellet upon impact from a wreathing event. For example, hail damage could release a pigment from a roofing pellet, wherein the pigment may be used to quantify intensity or locate hail damage or damage from another foreign object strike. A pigment may also designate specific areas of a roofing product. For example, a pigment may designate a nail zone or indicate proper or improper application of a roofing product.

In some embodiments, an active ingredient may be non-water soluble. Roofing pellets of the present disclosure may comprise pellets having active ingredients that become exposed through natural weathering and/or degradation of a polymer matrix material. In some embodiments, an active ingredient incorporated into a roofing product may not rely on water solubility to be transferred from an inner portion of a pellet to an outer portion. Through degradation of a polymer matrix material, active ingredients such as non-water soluble compounds may be activated without being transported through a roofing pellet by water. Active ingredients such as non-water soluble compounds may also be protected from activation until a polymer matrix material is degraded. A non-water soluble compound may include titanium dioxide. Titanium dioxide may desirably provide for NOx (e.g., nitric oxide and nitrogen dioxide) scrubbing activity. Additionally, titanium dioxide may provide for desirable mechanical exfoliation of a roofing pellet, which may increase a surface area or number of active sites of the roofing pellet and increase exposure/leaking of an active ingredient. In some embodiments, a roofing pellet may comprise a magnetic agent or traceable particles. A magnetic agent may desirably provide for a roofing product with traceable particles that may be used to image a roof over time to assess movement of a roof, movement of shingles, or establish a unique identifier for the roof. Additionally, a pellet may comprise water soluble compounds. For example, a roofing pellet may comprise a salt (e.g., rock salt), which may desirably provide for a freezing point depression of water. A roofing pellet may comprise a salt, which may desirably prevent ice damming.

Active ingredients of the present disclosure may be incorporated into a pellet in various amounts or at various concentrations. In some embodiments, a weight ratio between a polymer matrix and an amount of active ingredient present may be about 1:99 to about 90:10. For example, a weight ratio between a polymer matrix and an amount of active ingredient present may comprise about 1:99, or about 5:95, or about 10:90, or about 20:80, or about 30:70, or about 40:60, or about 50:50, or about 60:40, or about 70:30, or about 80:20, or about 90:10. In some embodiments, a weight ratio between a roofing product and an amount of active ingredient present may be about 1:99 to about 90:10. For example, a weight ratio between a roofing product and an amount of active ingredient present may include about 1:99, or about 5:95, or about 10:90, or about 20:80, or about 30:70, or about 40:60, or about 50:50, or about 60:40, or about 70:30, or about 80:20, or about 90:10.

### Active Ingredient Activation

Roofing products of the present disclosure may rely on different mechanisms for activation of active ingredients disposed therein. For example, natural weathering and/or degradation may be an activation mechanism for a function provided by a selected active ingredient. However, other environmental stimuli may serve as an activation mechanism for a selected active ingredient. For example, a pellet within the present disclosure may be formulated to withstand natural weathering but deliver an active ingredient, such as a fire suppressant, when a temperature of a roofing product reaches a particular point causing a polymer matrix material to melt. Additionally, an active ingredient of a pellet may be activated or accessed through impact of a foreign object at or above a threshold force. For example, an active ingredient of a pellet may be activated through impact of hail or rain. In some embodiments, an active ingredient of a pellet may be activated or accessed through exposure to standing water, organic chemicals, oxidizing agents, reducing agents, aqueous mixtures, or combinations thereof. Activation may include provoking instantaneous activation upon exposure or activation through exposure of a threshold time period.

### EXAMPLE EMBODIMENTS

In some embodiments of the present disclosure, an active ingredient is an antimicrobial agent which may desirably increase algae resistance and prevent or slow a growth of algae and microorganisms on a roofing product. In some embodiments, an antimicrobial agent may be cuprous oxide. Other suitable antimicrobial agents may be one or more metal oxides, metal powders, powders of metal alloys, copper compounds, metal sulfides, metal salts, organo-metallic compounds, known antimicrobial products, and combinations thereof. Examples of metal powders include, but are not limited to, zinc, copper, lead, tin, bronze, nickel, cadmium, or silver. Examples of metal compounds include, but are not limited to, zinc borate or barium metaborate. Various other antimicrobial agents may be incorporated as an active ingredient without departing from the scope of the present disclosure.

In some embodiments of the present disclosure, an active ingredient is a fire suppressant, flame retardant, or a combination thereof, which may desirably prevent a spread of a fire on a roofing product. In some embodiments, a fire suppressant may be comprise a flame resistant polymer, a flame resistant small molecule, or a combination thereof. For example, a flame resistant polymer may comprise aromatic polyamides, polypropylenes, polyesters, polyimides, and copolymers thereof. Additionally, a flame resistant small molecule may comprise halogenated small molecules including polybrominated dibenzodioxins, polybrominated dibenzofurans, brominated diphenyl ethers, phosphorous tribromide, phosphorous trichloride, or combinations thereof. In some embodiments, flame retardant chemicals may include mineral systems such as aluminum hydroxide or magnesium hydroxide. A flame retardant may or may not rely on char formation or intumescence to inhibit or retard a flame or heat source.

Roofing products of the present disclosure may incorporate one or more types of active ingredients. For example, a roofing product may comprise different pellets having different active ingredients. A roofing product may comprise a first set of pellets having antimicrobial agents dispersed therein. A roofing product may further comprise a second set of pellets having fire suppressants disposed therein. In some embodiments, pellets may also comprise a plurality of different active ingredients therein. For example, pellets may comprise a polymer matrix mixed with both antimicrobial agents and fire suppressants.

In some embodiments, a roofing product may also comprise components or pellets having no active ingredients therein. For example, pellets having an active ingredient may be mixed with pellets having no active ingredients. Mixing pellets having active ingredients with pellets having no active ingredients may desirably control a concentration of an active ingredient throughout a roofing product, and may desirably control the cost associated with incorporating an active ingredient. In some embodiments, components with no active ingredients may primarily comprise crushed stone, such as Andesite, commonly known as trap rock, or nepheline syenite.

### Methods of Manufacturing

Another aspect of the present disclosure provides for methods of manufacturing roofing products. In some embodiments, methods may comprise preparing a plurality of pellets. Pellets may be prepared by mixing a polymer matrix with at least one of an active ingredient. An active ingredient may be mixed such that it is evenly distributed throughout the volume of a polymer matrix.

In some embodiments, methods may comprise mixing a plurality of pellets having active ingredients with other compounds. For example, a plurality of roofing pellets having antimicrobial agents therein may be mixed with a plurality of pellets having fire suppressants therein. As another example, a plurality of roofing pellets having active ingredients therein may be mixed with a plurality of pellets or other compounds with no active ingredients therein. Preparing a plurality of roofing pellets may also comprise mixing pellets of various sizes and shapes.

Methods may also comprise applying to a bituminous base a plurality of roofing pellets. Pellets may be applied to a roofing material, such a bituminous base, in various manners. In some embodiments, a plurality of roofing pellets are directly adhered to an exterior surface of a bituminous base. In some embodiments, pellets having active ingredients may be separately applied to a top surface of a roofing product, such as a roofing shingle. In some embodiments, pellets having active ingredients may be mixed with non-functionalized pellets and applied together en masse.

According to some embodiments, a roofing pellet or a plurality of roofing pellets may be manufactured in various sizes, shapes, and with differing pellet size distributions. For example, a roofing pellet may be manufactured with under water pelletizing, wherein a matrix-active compound mixture may be extruded through a die, passed through a cutting blade submerged in a cooling water bath. A pellet or a plurality of pellets may be separated from a feed and freely suspended in water, wherein they may revert to a lowest or lower surface energy configuration. In some embodiments, a sphere may be a lower or lowest surface energy configuration. A pellet or plurality of pellets may be manufactured through a strand palletization procedure. In a strand palletization procedure, a material may be extruded through a die, pulled as a string through a cooling bath, then cut into pellets, which may lead to more cylindrical pellets. Pellets may also be formed to a larger size and ground to a smaller or different size and/or shape. In some embodiments, a pellet or a plurality of pellets may be mixed with stone granules. A pellet or a plurality of pellets may be exposed or unexposed in areas of a top surface of a shingle or bituminous base.

### Additional and Alternative Embodiments

As will be understood by those skilled in the art who have the benefit of the instant disclosure, other equivalent or alternative roofing products and systems can be envisioned without departing from the description contained herein. Accordingly, the manner of carrying out the disclosure as shown and described is to be construed as illustrative only.

Persons skilled in the art may make various changes in the shape, size, number, and/or arrangement of parts without departing from the scope of the instant disclosure. For example, the type of active ingredient used or incorporated in a roofing pellets may be varied. As another example, the distribution and/or concentration of an active ingredient in a roofing pellet may be varied. In addition, the size of the described roofing pellets, roofing shingles, and/or roofing products may be scaled up or down as appropriate for particular applications. Each disclosed method and method step may be performed in association with any other disclosed method or method step and in any order according to some embodiments. Where the verb “may” appears, it is intended to convey an optional and/or permissive condition, but its use is not intended to suggest any lack of operability unless otherwise indicated. Where open terms such as “having” or “comprising” are used, one of ordinary skill in the art having the benefit of the instant disclosure will appreciate that the disclosed features or steps optionally may be combined with additional features or steps. Such option may not be exercised and, indeed, in some embodiments, disclosed systems, compositions, apparatuses, and/or methods may exclude any other features or steps beyond those disclosed herein. Elements, compositions, devices, systems, methods, and method steps not recited may be included or excluded as desired or required.

Also, where ranges have been provided, the disclosed endpoints may be treated as exact and/or approximations as desired or demanded by the particular embodiment. Where the endpoints are approximate, the degree of flexibility may vary in proportion to the order of magnitude of the range. For example, on one hand, a range endpoint of about 50 in the context of a range of about 5 to about 50 may include 50.5, but not 52.5 or 55 and, on the other hand, a range endpoint of about 50 in the context of a range of about 0.5 to about 50 may include 55, but not 60 or 75. In addition, it may be desirable, in some embodiments, to mix and match range endpoints. Also, in some embodiments, each figure disclosed (e.g., in one or more of the examples, tables, and/or drawings) may form the basis of a range (e.g., depicted value+/−about 10%, depicted value+/−about 50%, depicted value+/−about 100%) and/or a range endpoint. With respect to the former, a value of 50 depicted in an example, table, and/or drawing may form the basis of a range of, for example, about 45 to about 55, about 25 to about 100, and/or about 0 to about 100. Disclosed percentages are weight percentages except where indicated otherwise.

The title, abstract, background, and headings are provided in compliance with regulations and/or for the convenience of the reader. They include no admissions as to the scope and content of prior art and no limitations applicable to all disclosed embodiments.

### EXAMPLES

Some specific example embodiments of the disclosure may be illustrated by one or more of the examples provided herein.

### Example 1: Artificial Aging of Pellets of Various Polymer Compositions

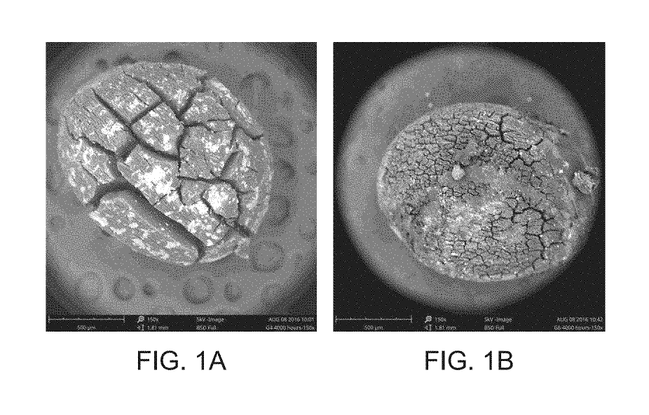

Two roofing pellet samples comprising different polymer bases were artificially aged by about 4,000 hours. The two roofing pellet samples were artificially aged by first hand applying each pellet sample to an asphaltic sheet, wherein the sheets were individually placed inside an Atlas Ci4000 Weather-Ometer and exposed according to ASTM G155 Cycle 1. Sample sheets were removed and photographed after various exposure times (up to about 4000 hr). At each exposure time a single pellet from each sample sheet was removed from the exposed area of the sample and mounted on a stage for evaluation using a NanoScience Instruments Phenom ProX scanning electron microscope. FIG. 1A depicts a scanning electron microscopy image of a pellet comprising polyethylene and a copper source, wherein the pellet has been aged by about 4,000 hours. FIG. 1B depicts a scanning electron microscopy image of a pellet comprising polypropylene and a copper source, wherein the pellet has been aged by about 4,000 hours.

### Example 2: Unaged and Aged Polypropylene Roofing Pellets

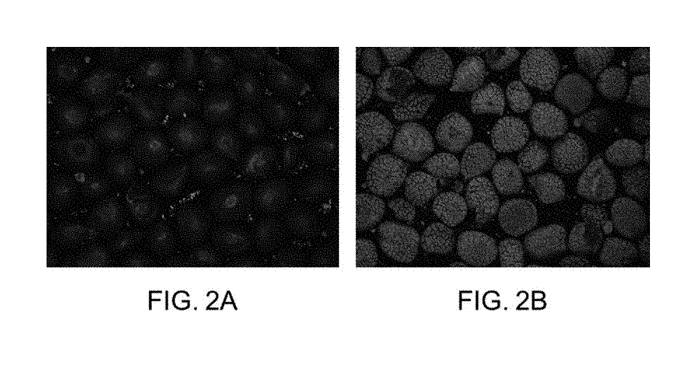

A roofing pellet sample comprising polypropylene and a microbial agent was treated to conditions to artificially age the roofing pellet sample by about 4,000 hours. FIG. 2B depicts a photographic image of a roofing pellet sample that was artificially aged, wherein FIG. 2A depicts a control sample that was not artificially aged.

### Example 3: Leaching of Active Ingredients from Various Pellet Types

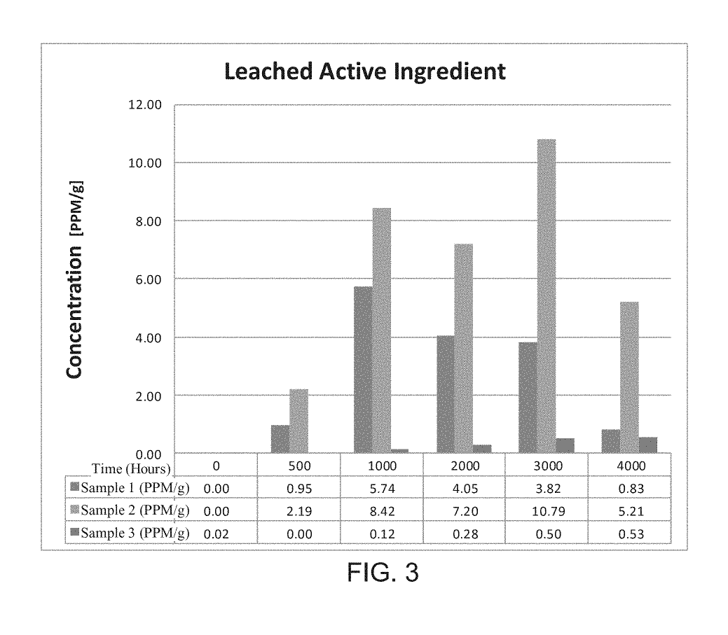

Three pellet sheet samples were made by applying one of three pellet types onto individual pellet sheets. Sample Sheet 1 includes pellets comprising polyethylene and a copper source, sample sheet 2 includes pellets comprising polypropylene and a copper source, and sample sheet 3 includes traditional roofing granules comprising a copper source. Each sheet samples was artificially aged while active ingredient leaching was measured. After designated exposure times, sheets were placed in 100 mL of deionized water in a sealed cleanroom metals-free bag and allowed to lay flat for about 30 minutes. After the bag was opened and a 10 mL samples was removed and analyzed using a Thermo iCAP6500 inductively coupled plasma optical emission spectrometer. The results are found in FIG. 3 and in Table 1.

TABLE 1
Leaching of Active Ingredient

| Time (Hours) | 0 | 500 | 1000 | 2000 | 3000 | 4000 |
|---|---|---|---|---|---|---|
| Sample 1 (PPM/g) | 0.00 | 0.95 | 5.74 | 4.05 | 3.82 | 0.83 |
| Sample 2 (PPM/g) | 0.00 | 2.19 | 8.42 | 7.20 | 10.79 | 5.21 |
| Sample 3 (PPM/g) | 0.02 | 0.00 | 0.12 | 0.28 | 0.50 | 0.53 |

What is claimed is:

1. A method of slowing the growth of at least one microorganism on a surface, the method comprising:
applying a plurality of pellets to the surface, wherein each pellet of the plurality of pellets comprises a polymer matrix and an antimicrobial agent, wherein the antimicrobial agent is dispersed throughout the volume of the polymer matrix, wherein natural weathering of the plurality of pellets releases the antimicrobial agent at a substantially uniform rate over a period of about or more than 20 years, and wherein the release of the antimicrobial agent slows the growth of microorganisms on a surface relative to a corresponding surface having an applied plurality of pellets without the antimicrobial agent.

2. The method according to claim 1, wherein the antimicrobial agent is selected from the group consisting of metal oxides, metal borates, metal powders, powders of metal alloys, copper compounds, metal sulfides, metal salts, organo-metallic compounds, and combinations thereof.

3. The method according to claim 1, wherein the antimicrobial agent is released through natural weathering of the plurality of roofing granules.

4. The method according to claim 1, wherein a ratio of the antimicrobial agent to the polymer matrix is from about 90:10 to about 1:99.

5. The method according to claim 1, wherein the plurality of pellets each have a diameter from about 0.25 mm to about 5.0 mm.

6. The method according to claim 1, wherein the polymer matrix comprises at least one of a stabilizing agent, de-stabilizing agent, and pigment.

7. The method according to claim 1, wherein the polymer matrix comprises a polymer selected from the group consisting of high density polyethylene, low density polyethylene, linear low density polyethylene; polypropylene; low and high impact polystyrene, polyvinyl chloride, acrylonitrile butadiene styrene, polyamide, polyester, polycarbonate, polyester, polyurethane, styrene butadiene styrene, styrene-butadiene rubber, styrene ethylene butylene styrene rubber, and acrylic.

8. A method of slowing the spread of a surface fire, the method comprising:
applying a plurality of pellets to a bituminous base, wherein each pellet of the plurality of pellets comprises a polymer matrix and a fire suppressant, wherein the fire suppressant is dispersed throughout the volume of the polymer matrix, wherein the polymer matrix is configured to melt at a temperature of about 50° C. less than the combustion temperature of the bituminous base, wherein melting of the polymer matrix releases the fire suppressant at a substantially uniform rate, and wherein the release of the fire suppressant slows the spread of a surface fire relative to a corresponding surface having an applied plurality of pellets without the fire suppressant.

9. A method of releasing an active ingredient to a surface of a shingle at a substantially uniform rate over a period of years, the method comprising:
affixing the shingle to an exterior surface, wherein the shingle comprises a bituminous base and a plurality of roofing pellets adhered to the bituminous base, wherein the plurality of pellets comprises a polymer matrix mixed with the active ingredient, wherein the active ingredient is dispersed throughout the volume of the polymer matrix,
contacting the shingle surface to an environmental stimulant, wherein contacting the shingle surface to an environmental stimulant releases the active ingredient from the plurality of pellets, and wherein the active ingredient provides additional functionality to the roofing product.

10. A roofing product, the roofing product comprising:
a bituminous base; and
a plurality of roofing pellets adhered to the bituminous base, wherein the plurality of pellets comprises a polymer matrix mixed with an active ingredient, wherein the active ingredient is dispersed throughout the volume of the polymer matrix, and wherein the active ingredient provides additional functionality to the roofing product.

11. The roofing product of claim 10, wherein the active ingredient is an antimicrobial agent.

12. The roofing product of claim 11, wherein the antimicrobial agent is selected from the group consisting of metal oxides, metal borates, metal powders, powders of metal alloys, copper compounds, metal sulfides, metal salts, organo-metallic compounds, and combinations thereof.

13. The roofing product of claim 11, wherein the active ingredient is released through natural weathering of the plurality of roofing granules.

14. The roofing product of claim 10, wherein the active ingredient is a flame suppressant.

15. The roofing product of claim 14, wherein the flame suppressant is selected from the group consisting of aromatic polyamides, polypropylenes, polyesters, polyimides, copolymers thereof, polybrominated dibenzodioxins, polybrominated dibenzofurans, brominated diphenyl ethers, phosphorous tribromide, phosphorous trichloride, aluminum hydroxide, magnesium hydroxide, and combinations thereof.

16. The roofing product of claim 14, wherein release of the active ingredient is heat activated.

17. The roofing product of claim 16, wherein release of the active ingredient occurs at about a temperature from about 200° F. to about 600° F.

18. The roofing product of claim 10, wherein a distribution of the active ingredient throughout the polymer matrix provides for substantially uniform release of the active ingredient over a period of time of about 30 years.

19. The roofing product of claim 10, wherein a ratio of the active ingredient to the polymer matrix is from about 90:10 to about 1:99.

20. The roofing product of claim 10, wherein the plurality of pellets each have a diameter from about 0.25 mm to about 5.0 mm.

21. The roofing product of claim 10, wherein the polymer matrix comprises at least one of a stabilizing agent, de-stabilizing agent, and pigment.

22. The roofing product of claim 10, wherein the active ingredient is non-water soluble.

23. The roofing product of claim 10, wherein the active ingredient is a liquid.

24. The roofing product of claim 10, wherein the active ingredient is active by natural degradation of the polymer matrix.

25. A method of manufacturing a roofing product, the method comprising:
mixing a polymer matrix with an active ingredient is form a plurality of pellets such that the active ingredient is dispersed throughout the volume of the polymer matrix, wherein the active ingredient has antimicrobial activity, flame retardant activity, or both antimicrobial and flame retardant activity; and
directly adhering the plurality of roofing granules to an exterior surface of a bituminous base.

26. The method of manufacturing a roofing product of claim 25, wherein the active ingredient is an antimicrobial agent.

27. The method of manufacturing a roofing product of claim 26, wherein the antimicrobial agent is selected from the group consisting of metal oxides, metal borates, metal powders, powders of metal alloys, copper compounds, metal sulfides, metal salts, organo-metallic compounds, and combinations thereof.

28. The method of manufacturing a roofing product of claim 26, wherein the active ingredient is released through natural weathering of the plurality of roofing granules.

29. The method of manufacturing a roofing product of claim 25, wherein the active ingredient is a flame suppressant.

30. The method of manufacturing a roofing product of claim 29, wherein the flame suppressant is selected from the group consisting of aromatic polyamides, polypropylenes, polyesters, polyimides, copolymers thereof, polybrominated dibenzodioxins, polybrominated dibenzofurans, brominated diphenyl ethers, phosphorous tribromide, phosphorous trichloride, aluminum hydroxide, magnesium hydroxide, and combinations thereof.

31. The method of manufacturing a roofing product of claim 29, wherein release of the active ingredient is heat activated.

32. The method of manufacturing a roofing product of claim 31, wherein release of the active ingredient occurs at a temperature from about 200° F. to about 600° F.

33. The method of manufacturing a roofing product of claim 25, further comprising distributing the active ingredient evenly throughout the polymer matrix to provide for substantially uniform release of the active ingredient over a period of time of about 30 years.

34. The method of manufacturing a roofing product of claim 25, wherein a ratio of the active ingredient to the polymer matrix is about 90:10 to about 1:99.

35. The method of manufacturing a roofing product of claim 25, wherein the plurality of pellets each have a diameter from about 0.25 mm to about 5.0 mm.

36. The method of manufacturing a roofing product of claim 25, the method further comprising adding to the polymer matrix at least one of a stabilizing agent, de-stabilizing agent, and pigment.

37. The method of manufacturing a roofing product of claim 25, wherein the active ingredient is non-water soluble.

38. The method of manufacturing a roofing product of claim 25, wherein the active ingredient is a liquid.

39. The method of manufacturing a roofing product of claim 25, wherein the active ingredient is active by natural degradation of the polymer matrix.
